(19) United States
(12) Patent Application Publication
(10) Pub. No.: US 2015/0380754 A1
(43) Pub. Date: Dec. 31, 2015

(54) FLOW BATTERY STACK WITH SENSING CHIP

(71) Applicants: YUAN ZE UNIVERSITY, Taoyuan City (TW); HOMYTECH CO., LTD., Taoyuan City (TW)

(72) Inventors: CHI-YUAN LEE, TAOYUAN CITY (TW); CHIN-LUNG HSIEH, TAOYUAN CITY (TW); CHIA-HUNG CHEN, TAOYUAN CITY (TW); KIN-FU LIN, TAIPEI CITY (TW); YUN-MIN LIU, CHANGHUA COUNTY (TW)

(21) Appl. No.: 14/720,622

(22) Filed: May 22, 2015

(30) Foreign Application Priority Data
Jun. 30, 2014 (TW) 103122538

(51) Int. Cl. H01M 8/04; H01M 8/24; H01M 8/02; H01M 8/18; H01M 8/20

(52) U.S. Cl. CPC H01M 8/04276; H01M 8/188; H01M 8/20; H01M 8/0273; H01M 8/24

(57) ABSTRACT

A flow battery stack includes a cell and two end plates, and the end plates are respectively disposed at two sides of the cell. The cell includes a membrane electrode assembly (MEA), a sensing chip, and a flow guide plate. The sensing chip has a frame part and a sensing part, and the sensing part connects to the frame part. The frame part is disposed between the MEA and the flow guide plate, and the sensing part extends to a flow region of the flow guide plate so as to sense the temperature or the flow capacity of a liquid in the flow region.

### BACKGROUND OF THE INVENTION

1. Field of the Invention

The present disclosure relates to a flow battery stack; in particular, to a flow battery stack with sensing chip.

2. Description of Related Art

As industry advances, the high consumption rate of fossil fuels has resulted in their shortage and an increase of environmental pollution. Thus, developing high-efficiency and low-pollution renewable energy to replace fossil fuels is an important trend.

Generally, the types of renewable energy include such as ocean current power, tidal power, geothermal energy, wind power, and solar power, wherein wind power and solar power are common renewable and clean energies because of abundant sunshine and strong winds. However, the supply of wind power and solar power are unstable because the quality of wind power and solar power are dependent on a changing climate. Accordingly, renewable energy and large-scale energy storage devices are necessary elements to build a complete power supply system for supplying stable electrical energy.

Redox flow battery (RFB) is a large-scale and high-efficiency electrochemical energy storage device. More specifically, the flow battery has a flow battery stack and two containers, and the containers respectively contain positive and negative electrolytes. Positive and negative electrolytes are respectively transmitted to the flow battery stack by pumps so that a chemical reaction takes place across an ion exchange membrane in the flow battery stack so as to produce electrical energy. The chemical reaction is reversible so the flow battery can be charged and discharged repeatedly. Therefore, electrical energy can be transformed into chemical energy by charging the flow battery when the supply of renewable energy has outstripped demand. Otherwise, the unstable production of electrical energy can be avoided by discharging the flow battery when the supply of renewable energy has not met demand.

It is noted that the temperature and the flow capacity of the electrolytes in the flow battery affects the performance and the useful life of the flow battery when a chemical reaction takes place in the flow battery. For example, agglomeration may be generated in the flow battery due to the non-uniform temperature in the flow battery during operation. Consequently, the flow channel that is for transmitting electrolytes in the flow battery may be blocked, which may impact the performance of the flow battery and shorten its useful life. Accordingly, how to effectively measure various performance parameters (e.g. temperature, flow capacity, and flow rate) of electrolytes in the flow battery stack of a flow battery is a very important issue.

### SUMMARY OF THE INVENTION

An exemplary embodiment of the present disclosure provides a flow battery stack which includes a cell and two end plates, and the end plates are respectively disposed at two sides of the cell. The cell includes a membrane electrode assembly (MEA), a sensing chip, and a flow guide plate. The sensing chip has a frame part and a sensing part, and the sensing part connects the frame part. The frame part is disposed between the MEA and the flow guide plate, and the sensing part extends to a flow region of the flow guide plate to sense the temperature or the flow capacity of a liquid in the flow region.

An exemplary embodiment of the present disclosure provides a flow battery which includes a cell and two end plates, and the end plates are respectively disposed at two sides of the cell. The cell includes an MEA, a sensing chip, and a flow guide plate. The flow guide plate has a groove, and the groove is configured for receiving the sensing chip. The sensing chip is disposed between the MEA and the flow guide plate, and the sensing chip extends to a flow region of the flow guide plate so as to sense the temperature or the flow capacity of a liquid in the flow region.

In summary, exemplary embodiments of the present disclosure provide a flow battery which is disposed with the sensing chip for sensing the temperature or the flow capacity of the liquid in the flow region, so the flow battery can instantly transmit a sensing result to the outside. Based on the sensing result, an outside monitor can instantly and appropriately regulate the flow rate of the liquid in the flow region so as to avoid blocking the flow channel due to an agglomeration phenomenon of the electrolytes in the flow battery.

In order to further the understanding regarding the present disclosure, the following embodiments are provided along with illustrations to facilitate the disclosure of the present disclosure.

### BRIEF DESCRIPTION OF THE DRAWINGS

FIG. 1 is a diagram showing the structure of a flow battery stack according to an embodiment of the present disclosure.

FIG. 2 is a diagram showing the structure of a flow battery control system according to an embodiment of the present disclosure.

FIG. 3 is a diagram showing the structure of a flow battery stack according to another embodiment of the present disclosure.

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

It should be understood that the usage of “first”, “second” and “third” intends to distinguish one element from another, and the element should not be limited by the term. Therefore, hereinafter a first element is interchangeable with a second element. The term “and/or” includes one and one or more of the combination in the group as described.

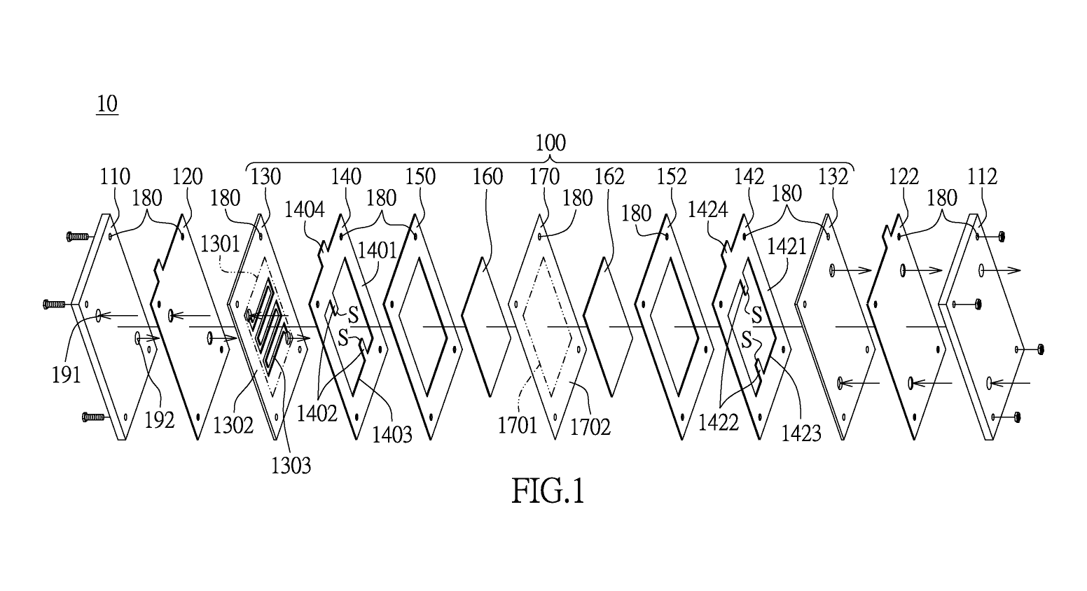

Please refer to FIG. 1, which shows the structure of a flow battery stack according to an embodiment of the present disclosure. The flow battery stack 10 includes a cell 100, an end plate 110, an end plate 112, a collector plate 120, and a collector plate 122. The cell 100 is disposed between the collector plate 120 and the collector plate 122. Further, the cell 100, the collector plate 120, and the collector plate 122 are disposed between the end plate 110, and the end plate 112.

The cell 100 includes a flow guide plate 130, a flow guide plate 132, a sensing chip 140, a sensing chip 142, an annular-shaped gasket 150, an annular-shaped gasket 152, an electrode sheet 160, an electrode sheet 162, and an ion exchange membrane 170. In the instant embodiment, the flow guide plate 130, the sensing chip 140, the annular-shaped gasket 150, the electrode sheet 160, the ion exchange membrane 170, the electrode sheet 162, the annular-shaped gasket 152, the sensing chip 142, and the flow guide plate 132 are sequentially stacked to form the cell 100. It is noted that the flow battery stack 10 can include at least one cell 100, and the exact number of the cells 100 in the flow battery stack 10 may be configured depending upon the practical operation need and the instant embodiment is not limited thereto.

The electrode sheet 160 and the electrode sheet 162, such as porous carbon felt or graphite felt, are disposed on the surface of two sides of the ion exchange membrane 170. The annular-shaped gasket 150 and the annular-shaped gasket 152 are also disposed at two sides of the ion exchange membrane 170. The annular-shaped gasket 150 and the annular-shaped gasket 152 have hollow structures, respectively. The shape of the hollow structure of the annular-shaped gasket 150 corresponds to the shape of the electrode sheet 160 in order to be disposed with the electrode sheet 160. The shape of the hollow structure of the annular-shaped gasket 152 corresponds to the shape of the electrode sheet 162 in order to be disposed with the electrode sheet 162. A Membrane Electrode Assembly (MEA) is formed with the ion exchange membrane 170, the electrode sheet 160, the electrode sheet 162, the annular-shaped gasket 150, and the annular-shaped gasket 152.

The flow guide plate 130 includes a flow region 1301, a locking region 1302, and a flow channel 1303, wherein the flow channel 1303 is disposed in the flow region 1301 and serves to allow a liquid (i.e. positive and negative electrolyte) to flow in the flow battery stack 10. The structure of the flow guide plate 132 is similar to the structure of the flow guide plate 130 so the present disclosure will not describe it here again.

The sensing chip 140 is disposed between the MEA and the flow guide plate 130, and the sensing chip 142 is disposed between the MEA and the flow guide plate 132. The sensing chip 140 includes a frame part 1401, a sensing part 1402, and a connecting part 1404. The frame part 1401 is a closed annular-shaped frame. The sensing part 1402 connects to the inside edge of the closed annular-shaped frame and extends to the flow region 1301 of the flow guide plate 130 so as to sense the temperature or the flow capacity of the liquid in the flow channel 1303 of the flow region 1301. The connecting part 1404 is a conductive output interface and connected to an outside device so that the sensing result generated by the sensing part 1402 can be transmitted to a connected outside device. The structure of the sensing chip 142 is similar to the structure of the sensing chip 140 so the present disclosure will not discuss it further. It is noted that the flow battery stack 10 may be disposed with only one sensing chip, and the exact number of the sensing chips 140 or the sensing chips 140 in the flow battery stack 10 may be configured depend upon the practical operation need and the instant embodiment is not limited thereto.

The end plate 110, the end plate 112, the collector plate 120, the collector plate 122, the flow guide plate 130, and the flow guide plate 132 all have a liquid inlet region (i.e. liquid inlet hole 191) and a liquid outlet region (i.e. liquid outlet hole 192). The liquid inlet holes 191 are configured for injecting the liquid into the flow battery stack 10. The liquid outlet holes 192 are configured for draining the liquid from the flow battery stack 10. The liquid inlet holes 191 of the flow guide plate 130 connect to the flow channel 1303, and the liquid outlet holes 192 of the flow guide plate 130 connect to the flow channel 1303.

In addition, the end plate 110, the end plate 112, the collector plate 120, the collector plate 122, the flow guide plate 130, the flow guide plate 132, the sensing chip 140, the sensing chip 142, the annular-shaped gasket 150, the annular-shaped gasket 152, and the ion exchange membrane 170 all have a plurality of through-holes 180. The position of the through-holes 180 correspond to each other, and the through-holes 180 are configured for receiving a plurality of fasteners so as to lock the flow battery stack 10 combined into one. The fasteners may be bolts and nuts, but the instant embodiment is not limited thereto.

In the instant embodiment, the ion exchange membrane 170 includes an ion exchange region 1701 and a frame region 1702. The ion exchange region 1701 corresponds to the electrode sheet 160 and the electrode sheet 162, and the electrode sheet 160 and the electrode sheet 162 are attached on the surface of two sides of the ion exchange region 1701. The frame region 1702 is disposed with a plurality of through-holes 180 in order to receive a plurality of fasteners. Thus, the frame region 1702, the annular-shaped gasket 150, and the annular-shaped gasket 152 can be considered to be the locking region of the MEA. The frame part 1401 of the sensing chip 140 is disposed between the locking region of the MEA and the locking region 1302 of the flow guide plate 130, and the frame part 1421 of the sensing chip 142 is disposed between the locking region of the MEA and the locking region of the flow guide plate 132. In this way, leakage of the electrolytes from the flow battery stack 10 with the sensing chip 140 and the sensing chip 142 can be avoided when the electrolytes are injected into the flow battery stack 10.

More specifically, as in the aforementioned description (take the frame part 1401 for instance), the frame part 1401 is a closed annular-shaped frame and disposed with a plurality of through-holes 180, and the through-holes 180 of the frame part 1401 correspond to the locking region of the MEA and the locking region 1302 of the flow guide plate 130. Accordingly, by disposing the fasteners into the through-holes 180 of the frame part 1401, the locking region of the MEA and the locking region 1302 of the flow guide plate 130, the frame part 1401 can be tightly disposed and locked between the locking region of the MEA and the locking region 1302 of the flow guide plate 130 so as to avoid causing the leakage of the electrolytes from the flow battery stack 10 when the electrolytes are injected into the flow battery stack 10. In other words, through the structure design of the locking region in the sensing chip 140 or 142, the sealed condition of the flow battery stack 10 will be not weaken even though the flow battery stack 10 is disposed with a plurality of sensing chips 140 or 142.

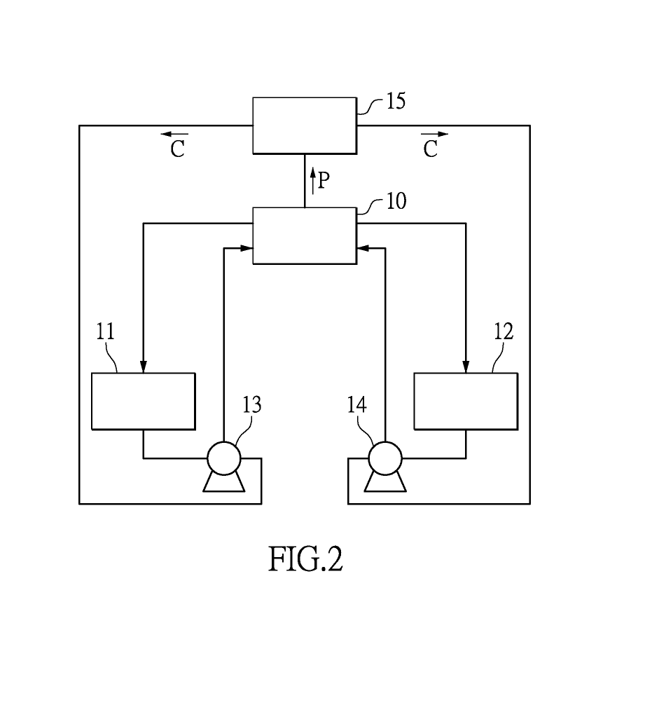

Please refer to FIG. 1 and FIG. 2. FIG. 2 shows the structure of a flow battery control system according to an embodiment of the present disclosure. The flow battery control system includes the flow battery stack 10, a container 11, a container 12, a pump 13, a pump 14, and a controller 15. The flow battery stack 10, container 11, container 12, pump 13, and pump 14 form a flow battery, and the flow battery may be a vanadium redox flow battery, a lithium-ion flow battery, a lead-acid flow battery or other type flow battery.

The container 11 and the container 12 are respectively injected with positive electrolyte and negative electrolyte. The container 11 is connected to the flow battery stack 10 and the pump 13, and the container 12 is connected to the flow battery stack 10 and the pump 14. The flow battery stack 10 is further disposed with pipelines, and the pipelines are respectively connected to the container 11 and the container 12. The flow battery stack 10 is injected with electrolytes from the container 11 and the container 12 through the pump 13 and the pump 14 so as to cause a chemical reaction (i.e. oxidation-reduction reaction) in the flow battery stack 10.

In the instant embodiment, the controller 15 is electrically connected to the connecting part 1404, the connecting part 1424, the pump 13, and the pump 14 in the flow battery stack 10. The controller 15 is configured for receiving sensing signals P transmitted by the connecting part 1404 and the connecting part 1424. The controller 15 correspondingly controls the pump 13 and the pump 14 to regulate the flow rate of the electrolyte in the flow battery stack 10 according to the sensing signals P received. The controller 15 may be a microcontroller, but the instant embodiment is not limited thereto.

More specifically, as shown in FIG. 1, the sensing part 1402 and the sensing part 1422 include a plurality of sensors S, respectively. The frame part 1401 and the sensing part 1421 are disposed with conductive lines so that the two sensors S of the sensing part 1402 can be connected to the connecting part 1404 and the two sensors S of the sensing part 1422 can be connected to the connecting part 1424. Further, the two sensors S of the sensing part 1402 respectively extend to the liquid inlet hole 191 and the liquid outlet hole 192 of the flow guide plate 130 so as to sense the temperature and the flow capacity of the liquid in the flow channel 1303. The two sensors S in the sensing part 1422 respectively extend to the liquid inlet hole 191 and the liquid outlet hole 192 of the flow guide plate 132 so as to sense the temperature and the flow capacity of the liquid in the flow channel of the flow guide plate 132. In the instant embodiment, the sensor S may be a flexible micro temperature sensor, a flexible micro flow sensor, or a flexible micro sensor with temperature and flow sensing function. The flexible micro temperature sensor or the flexible micro flow sensor, such as a resistive wire pattern, is produced based on the microelectromechanical systems (MEMS) technology. The flexible micro sensor has many advantages such as small size and thin sensing layer.

Taking the micro temperature sensor for example, its sensing principle is based on the resistance property of the micro temperature sensor. More specifically, when a liquid flows through the micro temperature sensor, the resistance of the micro temperature sensor increases with increasing temperature of the liquid sensed and decreases with decreasing temperature of the liquid sensed. Therefore, the temperature of the liquid sensed by the micro temperature sensor can be extrapolated by measuring the resistance of the sensor. On the other hand, taking the micro flow sensor for example, its sensing principle is also based on the resistance property of the micro flow sensor. More specifically, a certain voltage is applied to the micro flow sensor so as to heat the micro flow sensor and correspondingly form a stable temperature field around the micro flow sensor. When a liquid with certain flow rate flows through the micro temperature sensor, the heat of the temperature field is taken away by the flowing liquid so as to cause a temperature decrease of the micro temperature sensor, and then the resistance of the micro temperature sensor decreases with decreasing temperature of the micro temperature sensor. Accordingly, the flow capacity of the liquid sensed by the micro flow sensor can be extrapolated by Ohm's law.

Therefore, by processing and analyzing the sensing signals P transmitted by the sensors S, the controller 15 can instantly and appropriately regulate the flow rate of the electrolyte in the flow channel of the flow guide plate 130 and/or the flow guide plate 132 so as to reduce the blocking probability of the flow channel in the flow battery stack 10. In this way, the real-time monitoring and the microscopic diagnosis of the flow battery stack 10 can be realized, which will be useful for improving the performance of the flow battery and extending the useful life of the flow battery.

In addition, it is noted that the sensor S also may be a micro current sensor, a micro voltage sensor, or a micro sensor with various sensing functions. In this way, various performance parameters of the flow battery stack 10 can be measured and obtained through at least one sensor S in the flow battery stack 10. Correspondingly, the operation information of the flow battery stack 10 can be accurately and comprehensively monitored at all times. Thus, the type of the sensor S and the number of the sensors S in the sensing part 1402 (or the sensing part 1422) may be configured depending upon the practical operation need and the instant embodiment is not limited thereto. In another embodiment, the sensing part 1402 (or the sensing part 1422) may include a plurality of sensors S, and the sensors S may be arranged on the inside edge 1403 of the frame part 1401 in ring mode and extend to the flow channel 1303 from an inside edge 1403. In this way, the sensors S can sense the temperature, the flow capacity, or other performance parameters at different positions in the flow channel 1303, and the controller 15 can operate a suitable control procedure according to the analysis result of the sensing signals transmitted by the sensors S.

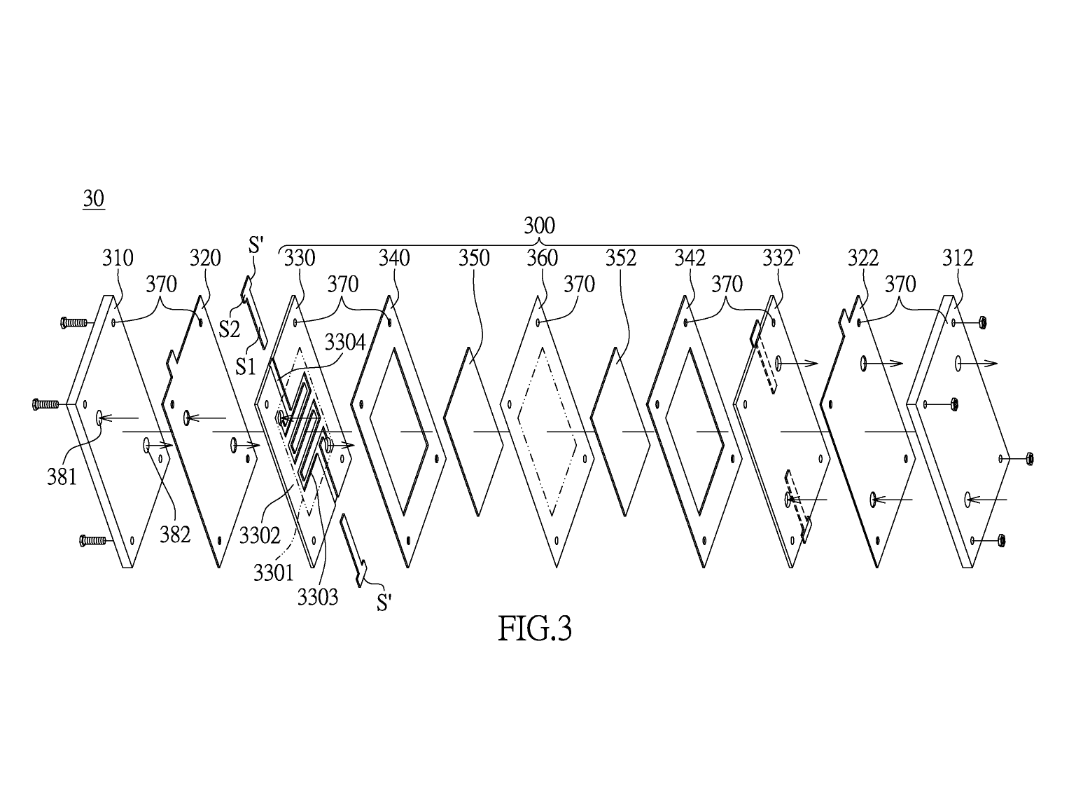

Please refer to FIG. 3, which shows the structure of a flow battery stack according to another embodiment of the present disclosure. The flow battery stack 30 includes a cell 300, an end plate 310, an end plate 312, a collector plate 320, and a collector plate 322. The cell 300 includes a flow guide plate 330, a flow guide plate 332, a plurality of sensing chips S′, an annular-shaped gasket 340, an annular-shaped gasket 342, an electrode sheet 350, an electrode sheet 352, and an ion exchange membrane 360. In the instant embodiment, the cell 300, end plate 310, end plate 312, collector plate 320, and collector plate 322 are also firmly locked together to form the flow battery stack 30 by piercing a plurality of fasteners into the through-holes 180 in the flow battery stack 30.

In the instant embodiment, as shown in FIG. 3, the instant embodiment differs from the embodiment in FIG. 1 in that the flow battery stack 30 does not include the sensing chip 140 and sensing chip 142, and the collector plate 320 and the collector plate 322 further includes at least one groove. The groove is configured for receiving the sensing chip S′. More specifically, the flow guide plate 330 includes two grooves 3304. The grooves 3304 extend to the flow region 3301 from the locking region 3302 and connect to the flow channel 3303 in the flow region 3301, so that the sensing chips S′ received in the grooves 3304 can sense the performance parameters (e.g. liquid temperature and flow capacity) of the liquid in the flow channel 3303. In the instant embodiment, the structure of the flow guide plate 332 is similar to the structure of the flow guide plate 330 so the present disclosure will not describe it further. It is noted that the exact number of the groove in the flow guide plate 330 and the flow guide plate 332 may be configured depend upon the practical operation needs and the instant embodiment is not limited thereto.

After disposing the sensing chips S′ in the flow guide plate 330 and the flow guide plate 332, two sensing chips S′ received in two grooves of the flow guide plate 330 are disposed between the MEA and the collector plate 320 and two sensing chips S′ received in two grooves of the flow guide plate 332 are disposed between the MEA and the collector plate 322.

In addition, the sensing chips S′ include a sensing part S1 and a connecting part S2, and the sensing part S1 includes a micro sensor (as illustrated in the aforementioned description), and the micro sensor in the sensing part S1 is connected to the connecting part S2. The connecting part S2 is a conductive output interface, and the conductive output interface is configured for connecting to an outside device (e.g. controller 15) and transmitting the sensing result generated by the sensing part S1 to the outside device connected. After that, the outside device can carry out related procedures according to the sensing result generated by the sensing part S1. It is noted that the exact number and type of the micro sensor in the sensing part S1 may be configured depend upon the practical operation need and the instant embodiment is not limited thereto.

To sum up, exemplary embodiments of the present disclosure provide a flow battery which is disposed with the sensing chip for sensing the temperature or the flow capacity of a liquid in the flow region, so the flow battery can instantly transmit a sensing result to the outside. Based on the sensing result, an outside monitor can instantly and appropriately regulate the flow rate of the liquid in the flow region so as to avoid blocking the flow channel due to an agglomeration phenomenon of the electrolytes in the flow battery. In this way, the performance of the flow battery can be improved and the useful life of the flow battery can be extended.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A flow battery stack, comprising:
a first cell, having a first membrane electrode assembly (MEA), a first sensing chip, and a first flow guide plate, wherein the first sensing chip has a first frame part and a first sensing part, the first sensing part connects to the first frame part, and the first frame part is disposed between the first MEA and the first flow guide plate, and the first sensing part extends to a first flow region of the first flow guide plate so as to sense the temperature or the flow capacity of the liquid in the first flow region;
a first end plate, disposed at one side of the first cell; and
a second end plate, disposed at another side of the first cell.

2. The flow battery stack according to claim 1, wherein the first MEA has a first locking region, and the first flow guide plate has a second locking region, and the first frame part is disposed between the first locking region and the second locking region.

3. The flow battery stack according to claim 2, wherein the first locking region has a plurality of first through-holes, and the first frame part has a plurality of second through-holes, and the second locking region has a plurality of third through-holes, wherein the position of the first through-holes, the second through-holes, and the third through-holes correspond to each other, and the first through-holes, the second through-holes, and the third through-holes are configured for receiving a plurality of fasteners.

4. The flow battery stack according to claim 1, wherein the first MEA has a ion exchange membrane, a first electrode sheet, a second electrode sheet, a first annular-shaped gasket, and a second annular-shaped gasket, the ion exchange membrane is disposed between the first electrode sheet and a second electrode sheet, wherein the first electrode sheet is disposed in the first annular-shaped gasket, and the second electrode sheet is disposed in the second annular-shaped gasket.

5. The flow battery stack according to claim 4, wherein the first frame part of the first sensing chip is a closed annular-shaped frame, and the first sensing part connects to an inside edge of the closed annular-shaped frame.

6. The flow battery stack according to claim 4, wherein the first sensing part has at least one resistive wire pattern.

7. The flow battery stack according to claim 1, wherein the first flow region comprises:
a flow channel, serving to allow the liquid to flow in the flow battery stack;
a liquid inlet region connecting to the flow channel, configured for receiving the liquid; and
a liquid outlet region connecting to the flow channel, configured for draining the liquid;
wherein, the first sensing part extends to the liquid inlet region or the liquid outlet region so as to sense the temperature or the flow capacity of a liquid in the flow channel.

8. The flow battery stack according to claim 1, wherein the first cell has a second flow guide plate and a second sensing chip, the second sensing chip has a second frame part and a second sensing part, the second sensing part connects to the second frame part, the second frame part is disposed between the first MEA and the second flow guide plate, and the second sensing part extends to a second flow region of the second flow guide plate so as to sense the temperature or the flow capacity of the liquid in the second flow region.

9. The flow battery stack according to claim 1, further comprising a second cell, and the second cell having a second MEA, a second sensing chip, and a second flow guide plate, wherein the second sensing chip has a second frame part and a second sensing part, the second sensing part connects to the second frame part, the second frame part is disposed between the second MEA and the second flow guide plate, and the second sensing part extends to a second flow region of the second flow guide plate so as to sense the temperature or the flow capacity of the liquid in the second flow region.

10. The flow battery stack according to claim 1, further comprising:
a first collector plate, disposed between the first cell and the first end plate;
a second collector plate, disposed between the first cell and the second end plate; and
a plurality of fasteners, configured for locking the first cell, the first collector plate, the second collector plate, a first end plate, and a second end plate.

11. A flow battery stack, comprising:
a cell, having an MEA, a sensing chip, and a flow guide plate, wherein the flow guide plate has a groove, the groove is configured for receiving the sensing chip, and the sensing chip is disposed between the MEA and the flow guide plate, the sensing chip extends to a flow region of the flow guide plate so as to sense the temperature or the flow capacity of a liquid in the flow region;
a first end plate, disposed at one side of the first cell; and
a second end plate, disposed at another side of the first cell.
